(19) United States
(12) Patent Application Publication
(10) Pub. No.: US 2004/0212582 A1
(43) Pub. Date: Oct. 28, 2004

(54) Electronic display system and display apparatus

(76) Inventors: Robbie Thielemans, Nazareth (BE); Herbert Van Hille, Cambridge, MA (US)

Correspondence Address: BARNES & THORNBURG, P.O. BOX 2786, CHICAGO, IL, 60690-2786, US

(21) Appl. No.: 10/689,428

(22) Filed: Oct. 20, 2003

Related U.S. Application Data
(60) Provisional application No. 60/466,168, filed on Apr. 28, 2003.

(51) Int. Cl. G09G 3/34

(52) U.S. Cl. 345/107

(57) ABSTRACT

The present invention is an electronic display system (100) that includes one or more electronic display apparatuses (110) wired or wirelessly connected to a network central processor (112). Each electronic display apparatus (110) further includes a receiver unit (114), a processor unit (116), a content database (118), driver circuitry (120), a printhead (122), and an electronic display (124). The electronic display (124) is typically a passive monochrome or full color display that is electrically writable and erasable and retains its image until erased and re-written by another transmission. In an alternative embodiment, electronic display (124) is a passive full-color display that is likewise electrically writable and erasable and retains its image until erased and re-written by another transmission.

### FIELD OF THE INVENTION

The present invention relates, in general, to advertising billboard devices and, more particularly, to street furniture electronic display units capable of dynamic-content presentation.

### BACKGROUND OF THE INVENTION

Outdoor advertising is one of the six main advertising media, alongside newspapers, magazines, television, radio, Internet Web sites, and cinema. Outdoor advertising is broadly defined as all advertising communication that is experienced outside of the home. The market can be segmented into three main sectors: billboard, transport, and street furniture.

The billboard is the traditional outdoor advertising product; this sector continues to take the greatest share of resources spent on outdoor advertising worldwide. The world leaders of the billboard market are Avenir (JCDecaux), Clear Channel, and CBS. The transport sector includes advertising on or in buses, trains, trams, underground and railway stations, ferry terminals, and airports. Transport advertising concessions are typically granted by private or municipal organizations. The rapid growth in air travel has created greater demand for airport panels, and new formats such as painted bus-sides have renewed clients' interest in the transport sector. Street furniture is the smallest but fastest growing area of outdoor advertising. Street furniture contracts are made with local authorities and typically last ten to twenty years. Street furniture is now also present in the private sector with installations in shopping malls and supermarkets.

Outdoor advertising devices are used to display various messages typically consisting of a combination of text and graphics. Traditionally, the message has been provided by way of fixed sheets that are pasted to a backing or by way of multiple fixed images and a mechanical means to display different posters at different times (roll-o-matic or triple-imagers). This traditional approach suffers from the inability to quickly change the displayed message since doing so requires the use of a crew. Electronic display devices provide the advantage of being easier to change the displayed message. Electronic display units are divided into two types: active content-display devices and passive content-display devices.

Active content-display devices are displays that only display dynamic content when they are actively being addressed or written on, such as, for example, computer monitors, movie theater screens, and light-emitting diode (LED) displays. While these active content-display devices are easily changed, they are difficult to manage and often require significant support resources to coordinate display content, have significant power requirements, and are very costly. By contrast, passive content-display devices are inexpensive and, when not being actively written to or addressed, retain a viewable image without active power requirements. An example of a material for forming such a passive content-display device is found in U.S. Pat. No. 4,126,854, entitled, “Twisting ball panel display.” The '854 patent describes a display system including a display panel composed of a plurality of particles that have an electrical anisotropy due to hemispherical surface coatings of different Zeta potential and their distribution in a volume of a dielectric liquid, and that also have an optical anisotropy due to the fact that the hemispherical surface coatings have different optical characteristics, which may be due to the color or other optical properties of the hemispherical coatings.

Several technical challenges must be overcome to encourage wide adoption of passive content-display devices within the outdoor advertising industry, in particular relating to the replacement of paper-based street-side advertising methods. For example, what is needed is a compact, cost-effective replacement for paper-based advertising. Furthermore, what is needed is a drop-in replacement for use in existing street furniture. Lastly, any passive content-display device for use in a street furniture application must be resistant to vandalism.

An example of a passive content-display device is found in reference to US-20020030638, entitled, “Apparatus for the display of embedded information.” The '638 patent application describes an apparatus for the electronic display of information, where the apparatus is a substrate incorporating a digital recording medium attached to or embedded within the substrate. The substrate further includes a flexible substrate display located on an exposed surface of the substrate, where the display is a medium capable of selectively displaying one of at least two possible colors at each pixel location thereon in order to produce a substrate medium that may be modified in accordance with a user's selection. While the '638 patent application describes a suitable low-cost passive content-display device, it does not address the specific needs relating to outdoor advertising applications, such as those needs relating to street furniture, and in particular to the replacement of paper-based advertising media.

It is therefore an object of the present invention to provide an electronic display system and/or passive content-display apparatus suitable for use in an indoor/outdoor advertising application.

An advantage of this invention can be to provide an electronic display system and/or passive content-display apparatus suitable for use in an outdoor advertising application that does not require a manual distribution/content update process.

An advantage of this invention can be to provide a low-cost, compact passive content-display apparatus suitable for use in an outdoor advertising application.

An advantage of this invention can be to provide a passive content-display apparatus suitable for use in an outdoor advertising application that is a drop-in replacement for existing paper-based displays.

An advantage of this invention can be to provide a passive content-display apparatus suitable for use in an outdoor advertising application that is not prone to vandalism.

An advantage of this invention can be to provide a passive content-display apparatus suitable for use in an outdoor advertising application that is viewable from two sides.

### BRIEF DESCRIPTION OF THE DRAWINGS

FIG. 1 illustrates a functional block diagram of an electronic display system in accordance with the present invention.

FIG. 2a and FIG. 2B illustrate a front view and a side view respectively of an example physical implementation of an electronic display apparatus in accordance with the present invention.

FIG. 3A illustrates a bottom view of a segment of a printhead for use within the electronic display apparatus of the present invention, showing a first example matrix of electrodes.

FIG. 3B illustrates a bottom view of a segment of a printhead for use within the electronic display apparatus of the present invention, showing a second example matrix of electrodes.

FIG. 4 illustrates a Detail A of the electronic display apparatus of FIG. 2.

FIG. 5 illustrates a side view of another example of the physical implementation of and electronic display apparatus in accordance with the present invention.

### DETAILED DESCRIPTION OF EMBODIMENTS OF THE INVENTION

In one aspect the present invention provides an electronic display system comprising:

at least one electronic display apparatus, the at least one electronic display apparatus comprising:

an electronic non-volatile display device which is able to retain an image after power is switched off,

a display driver circuit,

a storage means to store locally to the at least one electronic display apparatus a content of at least one image to be displayed on the at least one electronic non-volatile display device. Preferably, transferring means are provided for transferring the content of the at least one image from the local storage means to the display driver circuit for displaying the at least one image on the electronic non-volatile display device. Preferably a connecting means is provided to connect the electronic display system to a network central processor. The system may have one or more power supplies and a power supply may also be located locally with respect to the electronic display apparatus.

The electronic display system may furthermore comprise a diagnostics unit for sensing health or operating conditions, especially detrimental or emergency operation conditions of the at least one electronic display apparatus, and for transmitting a signal representative of the sensed condition to the network central processor.

The network central processor can be a server that provides dynamic content to the at least one electronic non-volatile display device. The means for storing locally to the at least one electronic display apparatus preferably keeps the storage of the at least one image after loss of connection between the display device and the network central processor.

The means to connect the at least one display apparatus to the network central processor may comprise any suitable connection such as a wired connection or a wireless connection. The means to connect the at least one electronic display apparatus to a network central processor usually comprises a receive and transmit unit.

In a further aspect the electronic non-volatile display device comprises passive display material. For example, the passive display material can comprise any of electrophoretic materials, electrochromic materials, cholesteric and nematic bistable LCD materials or bichromal bead materials.

A typical use of the above electronic display system is for outdoor advertising. To provide such a service as well as others, the present invention provides a method of displaying an image on an electronic non-volatile display device of an electronic display apparatus, which electronic non-volatile display device is able to retain an image after power is switched off. The method can comprise:

receiving from a network central processor at least one image to be displayed on the electronic non-volatile display device,

storing in a storage means local to the electronic non-volatile display device the at least one image to be displayed on the electronic non-volatile display device received from the network central processor,

transferring the at least one image from the local storage means to a display driver circuit, and

driving the electronic non-volatile display device in accordance with the image transferred to the display driver circuit.

In a further aspect the present invention can comprise an electronic display system having one or more display apparatuses that are updateable or changeable by electronic control, thereby eliminating the need for manual distribution/content update processes. More specifically, under the control of the electronic display system of the present invention, an image is created according to predetermined image data upon a passive electronic display within each electronic display apparatus. Each electronic display apparatus is a simple, inexpensive, low-power, passive display device that is electrically writable and erasable according to dynamic content supplied by a network central processor. Consequently, each electronic display apparatus provides an inexpensive, networkable, outdoor advertising device suitable for use in street furniture applications that is viewable from one or two sides.

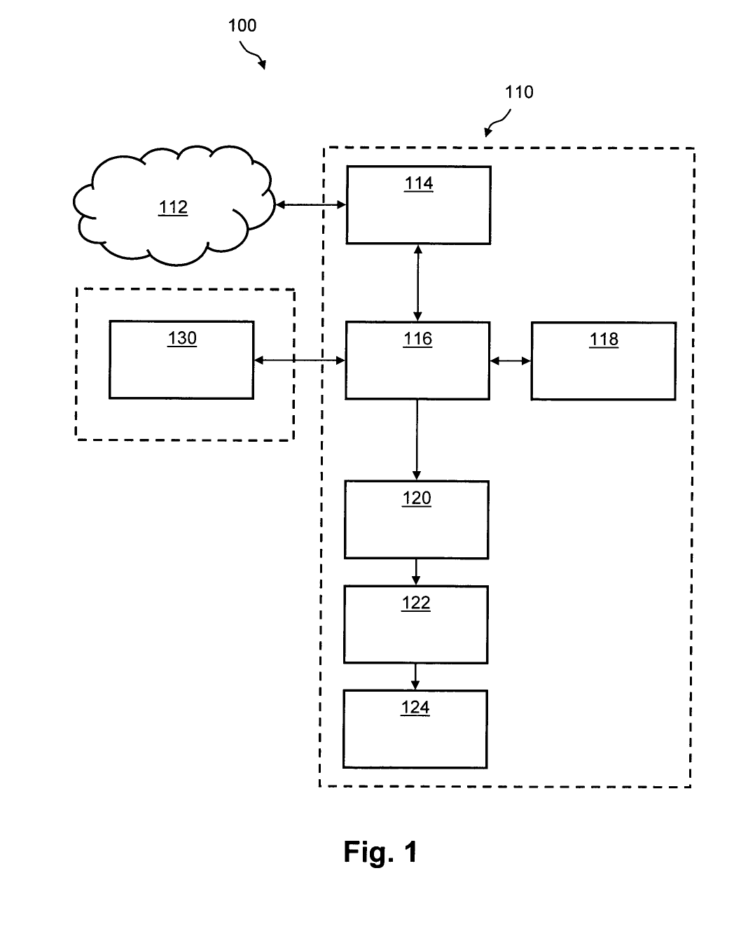

FIG. 1 illustrates a functional block diagram of an electronic display system 100 in accordance with an aspect of the present invention. Electronic display system 100 includes an electronic display apparatus 110 wired or wirelessly connected to a network central processor 112. Network central processor 112 may be a standard server that provides dynamic content to electronic display apparatus 110 via, for example, a standard transmitter (not shown). Furthermore, network central processor 112 is able to receive data such as system health information from electronic display apparatus 110 via, for example, a standard receiver (not shown). Network central processor 112 is representative of a national, regional, or local host computer. Electronic display apparatus 110 further includes a receive/transmit unit 114, a processor unit 116, a “local” content database 118, driver circuitry 120, a printhead 122, an electronic display 124, and optionally a diagnostics and sensors unit 130. FIG. 1 illustrates electronic display system 100 according to an embodiment of the present invention in its simplest form having only one electronic display apparatus 110; however, it is noted that electronic display system 100 may include a plurality of electronic display apparatuses 110 (even an onsite inkjet or laser plotter).

If chosen so, display apparatus 10, could also be constructed in a more traditional form, not requiring the printer mechanism printhead 122. Traditionally, a display is constructed as a Cartesian pixel array, a pixel being the smallest addressable image part and have the possibility to emit or reflect light with a certain intensity and color. To this effect, a pixel may contain sub-pixels, next to each other in essentially the same plane or stacked. Each subpixel will then emit or reflect light of only one color but at different intensities such as to mix together into a pixel color. Examples of this are for example LED displays, stacked cholesteric LCD etc.

Passive displays contain at least a display material having a memory function. This means that the image shown on the display, remains when power supply is removed. In line with most present manufacturing processes and in order to enable to display moving images, a passive display may consist of a cartesion array of pixel material or an array of Cartesian pixel arrays, visible from at least one side and driver circuitry, able to address each pixel within a certain frame period (for example 1/25s-5s). Every frame represent a new image on the display.

Typical such a passive display could assembled be as follows:

a first transparent layer or substrate in glass or plastic coated with a conductive material or material traces;

a display material layer, such as bistable electrophoretic or electrochromic materials or even LCD materials

a back layer or substrate, having a suitable electrode structure to address the individual pixel or subpixels, connections or vias to driver circuitry

a least a location with drivers, preferably located on the back side of the back layer substrate in the neighborhood of the pixels to reduce voltage and resistive losses

a form of encapsulation, if required by the display material, to seal from the environment against decay

Materials to create the front are very often ITO coated glass or ITO coated mylar (DuPont) sheets, back layer materials are very often polyimide sheets, having copper leads embedded or coated with graphite traces. These materials are also suitable for bonding electronic components such as drivers on the leads, such that the electronics can be applied near the pixels. A large display (more than 40″ diagonal) can be constructed from a single substrate with suitable processes or from several separate substrates or a combination of both such as using a single substrate of display material and front layer but multiple back substrates forming one larger one. Care should be taken that no lines at the borders of the tiles are visible as this reduces image quality.

Receive/transmit unit 114 is representative of any standard low-power receiver/transmitter device, capable of receiving data from and transmitting data to network central processor 112 via a wired or wireless connection. For example, image and timing data may be received by receive/transmit unit 114. By contrast, data relating to electronic display apparatus 110 may be transmitted to network central processor 112, such as a device ID of electronic display apparatus 110 system health data. As an example, electronic display apparatus 110 may include a way to detect pollution such as dust on the viewable area glass or increased humidity indicating that water may have entered and urgent service is required. If necessary, receive/transmit unit 114 performs an analog-to-digital conversion for providing a digital data output feeding processor unit 116.

Processor unit 116 is representative of any standard low-power processing device, such as a Jumptec DIMMPC/386. Processor unit 116 manages the image data and timing data (i.e., timing as to when to update the image) associated with one or more graphics images and subsequently feeds this data to content database 118.

Content database 118 is representative of any standard low-power storage or memory device, such as static or dynamic RAM or a computer hard disk. Content database 118 provides local storage of the image content for electronic display 124. This image content subsequently feeds driver circuitry 120 in a suitable data format.

Driver circuitry 120 includes standard or custom driver electronics suitable for feeding a typical image-generating device, such as printhead 122. Drivers suitable for use within driver circuitry 120 are, for example, voltage drivers for standard super twisted nematic (STN) liquid crystal display (LCD) drivers, any commercially available low-power drivers, or possibly commercially available high-voltage drivers, such as used for thermal printers manufactured by Supertex, Inc. (Sunnyvale, Calif.), depending on the switching characteristics of the materials used.

Printhead 122 is representative of a line-generating device. Printhead 122 generates the line-by-line content based upon data received via content database 118 and driver circuitry 120, and writes electronic display 124 accordingly for creating the desired image.

Electronic display 124 may be a passive display device formed of any commercially available re-writable material. Different types of such display materials exist including electrophoretic, electrochromic, cholesteric and nematic bistable LCD en bichromal bead materials. Electrophoretic materials are for example manufactured or under development at E Ink Corporation (Cambridge, Mass.), Canon (Japan), SiPix Imaging (Milpitas, Calif.), Papyron (Holland). Electrochromic materials change color when they gain or lose an electron when subject to an electrical potential. Such an electrochromic display technology is manufactured, for example, by NTera Ltd. (Dublin, Ireland). LCD displays are for example manufactured by Kent Displays (Kent, Ohio), Binem (France). Bichromal beads are e.g. manufactured by GyriconMedia (Palo Alto, Calif.)

For example, electronic display 124 may be formed of flexible electronic paper using E Ink's electrophoretic displays, Xerox's gyricon spheres, or bichromal beads as described in U.S. Pat. No. 4,126,854.

Optional diagnostics and sensors unit 130 is representative of electronics for monitoring various health conditions of electronic display apparatus 110. In a first example, diagnostics and sensors unit 130 may include sensors for measuring the dust and/or debris on the viewing surface of electronic display apparatus 110. In a second example, diagnostics and sensors unit 130 may include sensors for measuring humidity or differential current, which could indicate penetration of water into electronic display apparatus 110. In a third example, diagnostics and sensors unit 130 may include sensors for measuring heat that might indicate a short-circuited component or a fan that has stopped working within electronic display apparatus 110. In operation, diagnostics and sensors unit 130 may continuously transmit the health status of electronic display apparatus 110 to network central processor 112 via processor unit 116 and receive/transmit unit 114. Alternatively, diagnostics and sensors unit 130 may transmit the health status of electronic display apparatus 110 only upon detection of a problem. Furthermore, diagnostics and sensors unit 130 may be accessible via an external serial or parallel input/output port, i.e., I/O PORT. Local maintenance personnel may read the health status of electronic display apparatus 110 by connecting an external device, such as a personal digital assistant (PDA), to diagnostics and sensors unit 130 via I/O PORT.

Anyway, there could be a group of sensors which are monitored by a separate module (could be integrated in the processor) and which feeds the data into the processor. If required the required data could be passed on to the network for alerting.

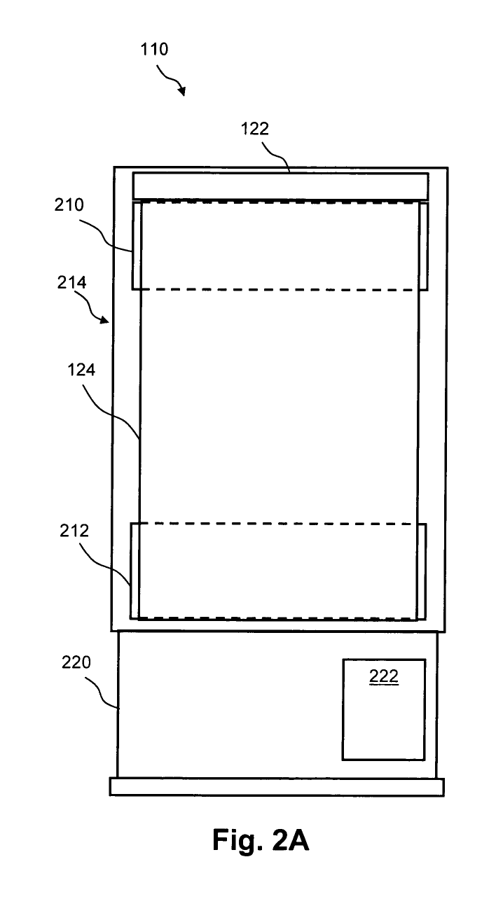

Further details of electronic display apparatus 110 and its elements are described in reference to FIGS. 2A, 2B, 3, and 4 below.

FIG. 2A and FIG. 2B illustrates a front view and a side view respectively of an example of a physical implementation of electronic display apparatus 110 in accordance with an embodiment of the present invention. Electronic display apparatus 110 includes electronic display 124 in the form of an endless loop of re-writable display material disposed upon a first roller 210 and a second roller 212, as shown in FIG. 2A and FIG. 2B. Rollers 210 and 212 may be hollow or solid cylinders formed of a conductive material, such as copper or aluminum, and have a typical diameter ranging between 2 and 20 cm. Printhead 122 is located in close proximity to electronic display 124 as it passes around roller 210. Printhead 122 spans the length of roller 210. Electronic display 124 disposed upon rollers 210 and 212 along with printhead 122 are all located within an enclosure 214 having a first viewable face 216 and a second viewable face 218. First viewable face 216 and second viewable face 218 may be formed of a transparent material, such as e.g. Plexiglas or glass, thereby allowing electronic display 124 to be viewed by passersby. This transparent material may have suitable means for shielding electronic display 124 from UV light and reducing adhesion of paint and dust. The remaining surfaces of enclosure 214 need not be transparent and may therefore be formed of any durable, waterproof, inexpensive material as is practical, such as e.g. plastic or aluminum, that is not prone to vandalism.

Enclosure 214 may subsequently be mounted upon a conventional pedestal 220 wherein a motor 222 may be housed along with other elements of electronic display apparatus 110, such as receive/transmit unit 114, processor unit 116, content database 118, and driver circuitry 120, which are for simplicity not shown in FIG. 2. Motor 222 may be any conventional stepper motor, that is mechanically connected to rollers 210 and 212 via well-known methods, such as belts, pulleys, gears, or a direct connection, thereby providing controlled rotation of rollers 210 and 212 at a fixed rotational speed, or in controlled increments. The physical location of motor 222, receive/transmit unit 114, processor unit 116, content database 118, and driver circuitry 120 is not limited to within pedestal 220; these elements may be located anywhere within electronic display apparatus 110 as is practical. For compactness, motor 222 may also be mounted e.g; within second roller 212.

For the purpose of illustration in this example, electronic display 124 is formed of a continuous sheet of Gyricon Media's SmartPaper™, which is a reusable display material that has many of the properties of regular paper, e.g., stores an image, reflects light, has a wide viewing angle, is flexible, and is relatively inexpensive. SmartPaper™ is a technology using an array of tiny (100 micron diameter or smaller) solid beads, with one hemisphere of each bead one color (e.g., white) and the other a different color (e.g., black, red, green, or blue). These beads are embedded in a flexible plastic sheet in small cavities surrounded by a liquid. Each bead carries an electrical charge. When an external electric field is applied, the bead rotates or gyrates. Adhesive forces between each bead and cavity wall require an electrical threshold be exceeded before it will rotate. This makes an image electrically printed onto the material stable and unchanging until erased by another transmission. In this way, electronic display 124 is representative of a monochrome display that is electrically writable and erasable.

The size of the viewable area of electronic display 124 may vary from several square inches to several square feet depending upon the application. The overall size of electronic display apparatus 110 and its elements are set accordingly.

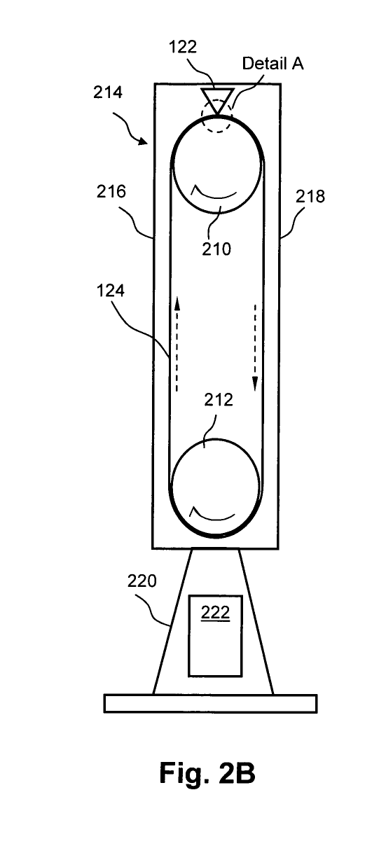

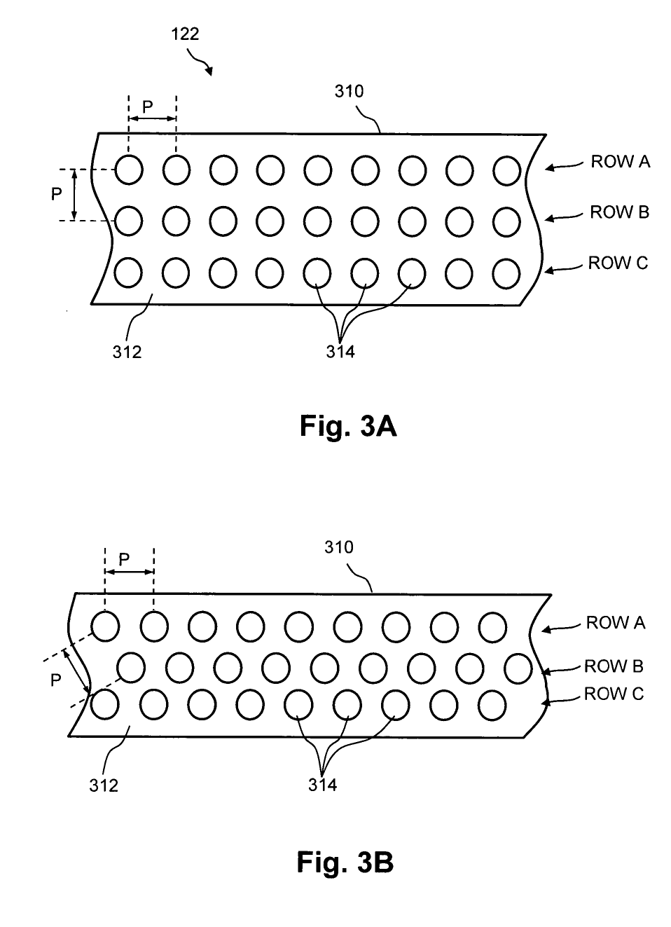

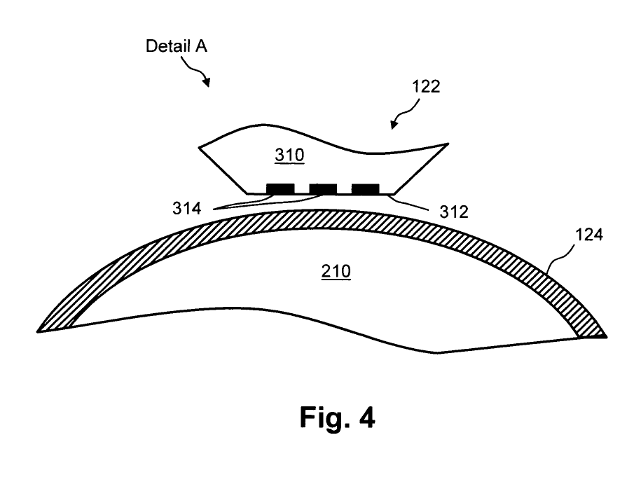

FIG. 3A illustrates a bottom view of a segment of printhead 122 showing a first example matrix of electrodes. As shown in FIG. 3A, printhead 122 further includes a main body 310 having a printhead surface 312 that, in operation, is oriented toward electronic display 124. Embedded within body 310 of printhead 122 is a plurality of electrodes 314 arranged in one or more rows along the length of printhead 122. Each row of electrodes 314 associates with one line of image data across the width of electronic display 124. The number of rows of electrodes 314 affects the achievable print rate of electronic display apparatus 110. More specifically, the more rows of electrodes 314 there are, the faster the print rate. As an example, FIG. 3A illustrates a ROW A, a ROW B, and a ROW C of electrodes 314 along the length of printhead 122, thereby forming a matrix 3×(n) of electrodes 314 within body 310. Electrodes 314 are arranged on a predetermined pitch (P), which for a low-resolution display may range typically between 1 and 2 mm (i.e., resulting in a display resolution of approximately 10 to 25 dpi). Electrodes 314 are arranged such that they are exposed through printhead surface 312 of printhead 122, as further illustrated in FIG. 4. The diameter of each electrode 314 typically ranges between 0.1 and 5 mm. Furthermore, the shape of electrodes 314 is not limited to circular; any user-defined shape is possible.

FIG. 3B illustrates a bottom view of a segment of printhead 122 showing a second example matrix of electrodes. FIG. 3B illustrates that electrodes 314 do not necessarily have to be arranged in a Cartesian grid; a hexagonal grid also can be used in order obtain tighter ball stacking for higher writing resolution. FIG. 3B illustrates that all electrodes 314 are equidistant, thereby achieving the highest writing density possible.

For specific applications, electrodes can also be clustered. Each cluster may have a relatively large number of electrodes to obtain high local writing density, but the total number of electrodes and consequently driver remains relatively low compared to the case where the whole width of the printhead would have the same high density.

This can be cost efficient if the display is primarily used for writing text characters in fixed locations. The high-density clusters make it possible to write high quality characters while there remainder of the display remains writeable at a lower resolution.

Until now, it has been assumed that the printhead covers the entire width of the display. But if writing speed is not an issue, one can choose to make the printhead of a much smaller width and move it back and forth over the display material to write row per row or set of rows per set of rows. The trade-off will be the cost of the mechanics for the extra movement versus having more driver circuitry (mm² of Silicon chip material).

On the other hand, if writing speed is an issue, then a waiting loop concept can be introduced. In a part of the display, invisible for the observer, the printhead can write the next image on the display during the time a first image is shown. When the next image is ready and time for showing the first image has elapsed, in a matter of seconds or less, the loop is moved the length of an image forward and the next image now becomes visible to the observer. This concept of course requires a loop, considerably longer. This may not necessary reflect in a substantially higher cost as the display material is produced in a bulk process. Furthermore, this creates more time to write a new image on the display material and one can reduce the printhead to a smaller width.

FIG. 4 illustrates a Detail A of electronic display apparatus 110 of FIG. 2B. More specifically, Detail A shows an expanded side view of the relationship between printhead 122 and electronic display 124 within electronic display apparatus 110. FIG. 4 shows printhead surface 312 of body 310 oriented toward the outer surface of the material of electronic display 124, while the inner surface of the material of electronic display 124 is in contact with roller 210. Electrodes 314 are exposed at printhead surface 312. Electrodes 314 are formed of electrically conductive material, such as copper or aluminum. By contrast, body 310 of printhead 122 is formed of non-conductive material, such as FR4 or glass fiber substrates, plastics, etc., to prevent an electrical short between individual electrodes 314. Electrodes 314 are electrically connected to driver circuitry 120, thereby allowing a voltage potential to be applied to each individual electrode 314 under the control of driver circuitry 120. Roller 210 may be formed of a conductive material, such as copper or aluminum. Alternatively, roller 210 may be formed of a non-conductive material, such as plastic or fiberglass, that has been coated with a highly conductive metal layer. Furthermore, roller 210 is electrically connected to ground potential. The gap between electrodes 314 and the outer surface of electronic display 124 must be sufficiently small to allow the electrical field emitting from electrodes 314 during operation to sufficiently influence the bi-stable material of electronic display 124. This gap is typically in the range of 0 to 0.5 mm, and is dependent on the material used. Lastly, rather than being flat, printhead surface 312 of body 310 with electrodes 314 embedded therein may be curved to follow the contour of roller 210, thereby ensuring a uniform gap between electrodes 314 and the outer surface of electronic display 124.

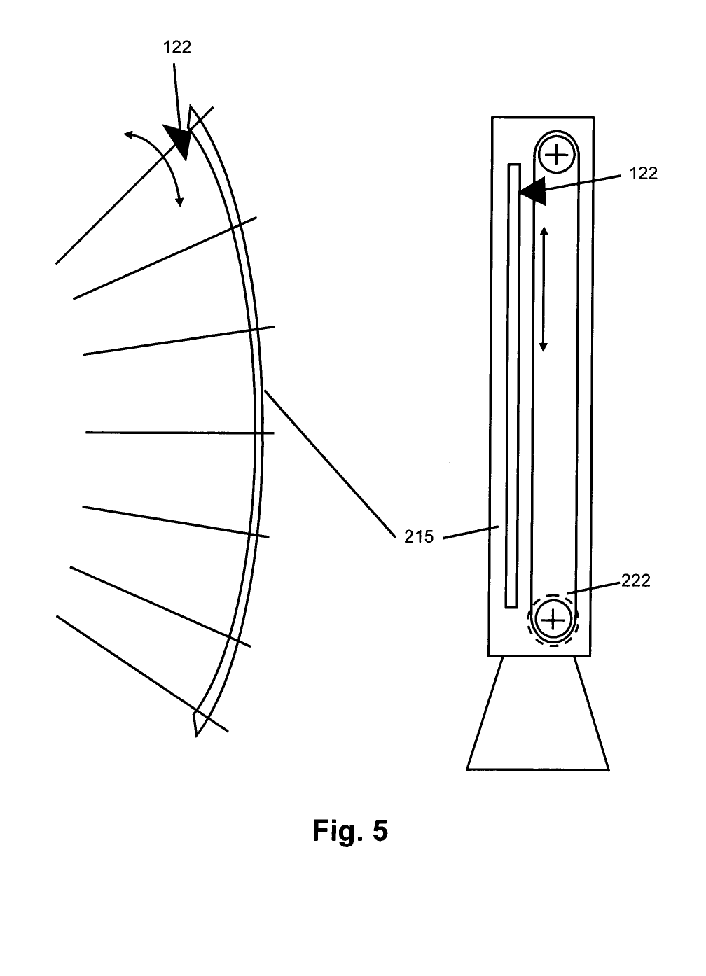

FIG. 5 demonstrates a variant of the print mechanism. The continuous loop system requires that any applied dispay material be suitable for flexible carrier substrates. However the bending radius of the substrate, when passing over the roll may be too small and cause too much stress on the display material. Or the display material may rely on glass to seal it adequately from environment (such as most LCD materials).

In such a case the display apparatus must be constructed as a fixed sheet or surface of display material while the printhead moves along the material to write line by line (for a horizontal printhead moving vertically) or column by column (for a vertical printhead moving horizontally). This is shown in FIG. 5.

If the display material can accept a slight bending radius, it is also possible to build curved surfaces and have the printhead move along a circular path to write the data.

Similarly to the wait loop concept of the display as in FIG. 2, straight rigid substrate could be written while invisible for the observer and then replace the shown picture for a knew one by using two equally sized substrates of display materials.

With reference to FIGS. 1, 2A, 2B, 3A, 3B, 4 and 5 the operation of electronic display system 100 is as follows. Network central processor 112 transmits image data and timing data associated with one or more desired advertisement display images to receive/transmit unit 114 of electronic display apparatus 110. This transmission may occur via, for example, a telephone wire, an Internet link, radio communication, cellular telephony, a microwave link, an infrared (IR) link, a local area network, or a satellite broadcast. Receive/transmit unit 114 receives the image data and timing data, provides analog-to-digital conversion if necessary, and subsequently passes this image data and timing data on to processor unit 116, where local management of this data occurs. Processor unit 116 transfers the image data associated with one or more desired advertisement display images to content database 118, where a schedule of consecutive images is stored. Based upon the timing data, processor unit 116 subsequently pulls up the image from content database 118 and sends specific drive data on to driver circuitry 120. Driver circuitry 120 supplies the proper positive or negative voltage potential to each individual electrode 314 of printhead 122 according to the image data, while roller 210, which is grounded, serves as the counter-electrode. Concurrently, motor 222 is activated and electronic display 124 translates past electrodes 314 of printhead 122 that are applying an electric field to electronic display 124 in a line-by-line fashion. There is suitable tension upon electronic display 124 to cause electronic display 124 to translate upon rollers 210 and 212 due to friction.

As electronic display 124 translates past electrodes 314 of printhead 122, the beads within electronic display 124 are exposed to an electric field line by line. When this electric field is applied, the beads within electronic display 124 rotate or gyrate to present one side or the other to the viewer. Adhesive forces between each bead and the wall of the cavity wherein they reside require that an electrical threshold be exceeded before they will rotate. In this way, an image is electrically printed line by line onto the material of electronic display 124, and the image remains stable and unchanging until erased by another transmission that may occur based upon timing data received by electronic display apparatus 110.

The translation of electronic display 124 past electrodes 314 of printhead 122 via motor 222 continues until an image is completed for viewing via first viewable face 216, and optionally until an image is completed upon electronic display 124 for viewing via second viewable face 218.

Processor unit 116 may alter the visual display of electronic display 124 as a function of the time according to timing data received from network central processor 112. For example, if electronic display 124 is located near a commuter highway visible to commuters, it may be desirable to display a first message on electronic display 124 during commuter rush hours, and to display a second different message on electronic display 124 at other times. This could be commanded via network central processor 112 or programmed locally within processor unit 116. A means of interfacing with traffic monitoring systems may be provided to allow the use of a plurality of electronic display apparatuses 110 in assisting traffic messaging along the highway.

In an alternative embodiment, electronic display 124 is held stationary within electronic display apparatus 110 and printhead 122 is mounted upon a motion control system that allows it to scan the full length of electronic display 124 and thereby print the advertising image.

In yet another embodiment of the present invention, full-color effects may be approximated by using optical filters in combination with the monochrome display material of electronic display 124. This may be done by simply placing a conventional optical filter in close proximity to electronic display 124 and between electronic display 124 and the viewer. The optical filter must be sized according to the viewable area of electronic display 124. The pattern of filtering material may approximate a pixel or sub-pixel, for example, a cluster of red/green/blue filter material. In this embodiment, alignment of the optical filter in relation to electronic display 124 is critical for proper visual presentation to the viewer.

In yet another embodiment of the present invention, in order to achieve a full-color display, electronic display 124 is formed of re-writable material, using the same principles as found in SmartPaper™, that is formed of multiple sets of vertical red/green/blue stripes that are repeated at a predetermined pitch along the width of electronic display 124. More specifically, each red stripe is formed of red/white bichromal beads, each green stripe is formed of green/white bichromal beads, and each blue stripe is formed of blue/white bichromal beads. In this way, a full-color display is formed via color pixels that are defined in the horizontal direction, but are not defined in the vertical direction. Gyricon Media, Inc., has suggested that several colors can thus be embedded in the material of electronic display 124; however, manufacturing may be a challenge. In this embodiment, alignment of electrodes 314 of printhead 122 to the known locations of these vertical red/green/blue stripes is critical for proper writing operation.

In yet another embodiment of the present invention, in order to achieve a full-color display, electronic display 124 is formed of re-writable material using the same principles as found in SmartPaper™, which is formed of multiple sets of horizontal red/green/blue stripes that are repeated at a predetermined pitch along the vertical length of electronic display 124. In this case, a reference can be attached on the outer ends of each stripe that can be read and fed back into driver circuitry 120.

In yet another embodiment of the present invention, electronic display 124 is formed of different color beads that are uniformly mixed but that have unique threshold voltages. In an example in which red requires 100 volts, green requires 70 volts, and blue requires 30 volts, the application of 100 volts activates the desired red beads, but also activates the green and blue beads. However, the subsequent application of 70 volts reverses the green and blue beads without affecting the red beads, thus defining the red content. Next, an application of 70 volts activates the desired green beads, but also the associated blue beads. Subsequent application of 30 volts reverses those blue beads without affecting the red and green beads, thus defining the green content. Finally, the desired blue content is defined by an application of 30 volts to activate the desired blue beads. Accordingly, a writing system with three rows could be used for performing this process simultaneously.

All of the above-mentioned principles particularly also apply to E Ink materials, in which it is actually easier to formulate pigment-filled capsules for different characteristics while still maintaining low voltages.

In summary, electronic display apparatus 110 is updateable or changeable by electronic control, thereby eliminating the need for manual distribution/content update processes. More specifically, under the control of electronic display system 100, an image is printed according to predetermined image data upon electronic display 124 of electronic display apparatus 110, which is a simple, inexpensive, low-power, passive display device that is electrically writable and erasable according to dynamic content supplied by network central processor 112. Consequently, electronic display apparatus 110 provides an inexpensive, networkable, durable outdoor advertising device suitable for use in street furniture applications that is viewable from one or two sides.

Furthermore, those skilled in the art will recognize that concepts and principles disclosed relating to electronic display system 100 are not limited to street furniture applications. Electronic display system 100 with one or more electronic display apparatuses 110 is applicable to other outdoor advertising applications, such as outdoor billboards or transport advertising.

1. An electronic display system comprising:
at least one electronic display apparatus, the at least one electronic display apparatus comprising
an electronic non-volatile display device which is able to retain an image after power is switched off,
a display driver circuit,
a storage means to store locally to the at least one electronic display apparatus a content of at least one image to be displayed on the at least one electronic non-volatile display device,
transferring means for transferring the content of the at least one image from the local storage means to the display driver circuit for displaying the at least one image on the electronic non-volatile display device, and
a connecting means to connect the electronic display system to a network central processor.

2. An electronic display system according to claim 1, furthermore comprising a power supply.

3. An electronic display system according to claim 1, furthermore comprising a diagnostics unit for sensing health conditions of the at least one electronic display apparatus, and for transmitting a signal representative of the sensed health condition to the network central processor.

4. An electronic display system according to claim 1, wherein the network central processor is a server that provides dynamic content to the at least one electronic non-volatile display device.

5. An electronic display system according to claim 1, wherein the means to connect the at least one display apparatus to a network central processor comprises a wired connection.

6. An electronic display system according to claim 1, wherein the means to connect the at least one display apparatus to a network central processor comprises a wireless connection.

7. An electronic display system according to claim 1, wherein the means to connect the at least one electronic display apparatus to a network central processor comprises a receive and transmit unit.

8. An electronic display system according to claim 1, wherein the electronic non-volatile display device comprises passive display material.

9. An electronic display system according to claim 8, wherein the passive display material comprises any of electrophoretic materials, electrochromic materials, cholesteric and nematic bistable LCD materials or bichromal bead materials.

10. An electronic display system according to claim 1, wherein the means for storing locally to the at least one electronic display apparatus keeps the storage of the at least one image after loss of connection to the network central processor.

11. Use of the electronic display system according to claim 1 for outdoor advertising.

12. Method of displaying an image on an electronic non-volatile display device of an electronic display apparatus, which electronic non-volatile display device is able to retain an image after power is switched off, the method comprising:
receiving from a network central processor at least one image to be displayed on the electronic non-volatile display device,
storing in a storage means local to the electronic non-volatile display device the at least one image to be displayed on the electronic non-volatile display device received from the network central processor,
transferring the at least one image from the local storage means to a display driver circuit, and
driving the electronic non-volatile display device in accordance with the image transferred to the display driver circuit.
